(19) United States
(12) Patent Application Publication
(10) Pub. No.: US 2026/0176976 A1
(43) Pub. Date: Jun. 25, 2026

(54) METHOD FOR ELECTROPHORETICALLY COATING A CERAMIC MATRIX COMPOSITE PART WITH AN ENVIRONMENTAL BARRIER

(71) Applicants: SAFRAN CERAMICS, LE HAILLAN (FR); CENTRE NATIONAL DE LA RECHERCHE SCIENTIFIQUE (CNRS), PARIS (FR); UNIVERSITE PAUL SABATIER TOULOUSE III, TOULOUSE (FR); INSTITUT NATIONAL POLYTECHNIQUE DE TOULOUSE, TOULOUSE (FR)

(72) Inventors: Lisa PIN, MOISSY-CRAMAYEL (FR); Simon ARNAL, MOISSY-CRAMAYEL (FR); Manon PRIOUX, TOULOUSE (FR); Florence ANSART, LABEGE (FR); Sandrine DULUARD, TOULOUSE (FR)

(73) Assignees: SAFRAN CERAMICS, LE HAILLAN (FR); CENTRE NATIONAL DE LA RECHERCHE SCIENTIFIQUE (CNRS), PARIS (FR); UNIVERSITE PAUL SABATIER TOULOUSE III, TOULOUSE (FR); INSTITUT NATIONAL POLYTECHNIQUE DE TOULOUSE, TOULOUSE (FR)

(21) Appl. No.: 18/713,035

(22) PCT Filed: Nov. 21, 2022
(86) PCT No.: PCT/FR2022/052133

§ 371 Date: May 23, 2024

(30) Foreign Application Priority Data
Nov. 24, 2021 (FR) FR2112452

(51) Int. Cl. F01D 5/28; C04B 35/44; C04B 41/45; C04B 41/50; C04B 41/52; C04B 41/85

(52) U.S. Cl. CPC F01D 5/288; C04B 35/44; C04B 41/4527; C04B 41/5096; C04B 41/52; C04B 41/85; C04B 2235/3418

(57) ABSTRACT

The invention relates to a method for producing an environmental barrier coating (12) electrophoretically on a ceramic matrix composite part (10), the method comprising the following steps:—E10: electrophoretic application to the surface(S) of the part (10) of a liquid suspension of a composition comprising at least one rare earth silicate powder and conductive fillers;—E20: drying of the suspension applied; and—E30: sintering heat treatment of the rare earth silicate powder, characterized in that use is made, as conductive fillers, of at least one nitrate selected from the group consisting of aluminium, yttrium and ytterbium nitrates in an amount of between 0.2 and 1 millimole per litre of liquid suspension.

### GENERAL TECHNICAL FIELD

The present invention concerns a method for electrophoretically coating a part made of ceramic matrix composite material (CMC) with an environmental barrier, in particular in the aeronautical field.

### STATE OF THE ART

CMC technologies have been developed for more than 20 years, with the objectives of applying these technologies in future generations of civil turbojets, in this case for the production of turbine parts and rear body parts.

CMC materials have good mechanical properties making them suitable for constituting structural elements and advantageously retain these properties at high temperatures.

However, under the operating conditions of aeronautical turbines (in particular: high temperature and corrosive environment), CMC materials are sensitive to corrosion, so it is necessary to protect them from premature degradation.

Thus, when a CMC part comprises a silicon carbide (SiC) matrix, the corrosion of the CMC results in the oxidation of the SiC to silica, which in the presence of water vapor volatilizes in the form of Si(OH)4 hydroxides. Corrosion phenomena cause premature degradation of the CMC.

Consequently, in order to guarantee the service life of CMCs, it is necessary to protect them from wet corrosion with an environmental barrier (EBC).

The EBC currently in use is typically composed of:
A silicon layer that provides protection from oxidation;
A layer of rare earth disilicate (generally Y or Yb) with the formula RE₂Si₂O₇ (where RE means rare earth) which makes it possible to act as a diffusion barrier to oxidizing species and to protect the CMC from corrosion at high temperature.
And a layer of yttrium monosilicate Y₂SiO₅ (YMS) to ensure resistance to recession and CMAS.

In aeronautics, the target parts for this application are, among others, turbine parts, such as blades or distributors, for which it is necessary to deposit a coating on the leading and trailing edges of the blades, to protect the parts from corrosion. However, this deposit must be as thin as possible, so as not to disrupt the aerodynamic performance of the coated part.

They can also be parts having holes, reliefs and, more generally, variations in shape, whether these variations are complex or not.

A strong constraint on these complex parts is therefore obtaining a homogeneous and thin coating (generally less than 100 μm for all three layers included) and more particularly:
Thickness of the silicon sublayer: Typically, less than 30 μm;
Thickness of the layer of RE₂Si₂O₇ around 30 μm;
Thickness of the YMS layer around 10 μm.

The silicon layer is generally deposited dry, that is, by thermal spraying or by chemical vapor deposition (CVD), whereas the rare earth silicate layers can be deposited dry or wet.

Thus, in terms of wet deposition, electrophoresis is known, which is a wet method in which the part is immersed in a liquid suspension of rare earth silicate powder under an electric field. The part, which is located at the anode or cathode according to its polarity, will be progressively covered with a deposit by means of the mobility of the powder under the influence of the electric field.

The electrophoretic method is generally chosen because it allows thin coatings to be produced on complex parts, unlike thermal spraying, which is a directional method and is therefore not suitable for the protection of complex parts.

Moreover, because thermal spraying uses powder whose size is around 60 μm, this makes it reasonably possible to produce covering layers with a minimum thickness of around 100 μm. Thus, this method cannot be used for the production of coatings on leading/trailing edges where the maximum thickness of the entire coating is 100 μm.

Finally, as regards methods of vapor deposition of rare earth silicate mixed oxide, it is noted that the chemistry of chemical vapor deposition is not controlled and that with physical vapor deposition (PVD) the required thicknesses are too large.

However, the use of the electrophoretic method does not allow the unique features of a part to be covered homogeneously, even if only the edges of a test piece. More precisely, the electric field concentration effects lead either to local excess thicknesses or to material shortages. Thus, this leads to material shortages at the top of the part and, in contrast, to material retention in the hollows of the part. This is called “geometric effect”.

This is particularly visible within the weave which constitutes the weft of the CMC piece, which weave results in an alternation of hollows and bumps.

However, these differences in thickness are detrimental to the coating because:
in areas where there is a lack of material: there is not enough coating to play its role of corrosion protection;
in areas where there are extra thicknesses, the coating can crack due to the high thickness which generates high thermomechanical stresses during the final sintering step.

To overcome these difficulties, document FR3084377 proposed to introduce conductive fillers into the electrophoresis bath, which normally makes it possible to obtain homogeneous coatings of uniform thickness.

However, the present applicant has found that the technique described in this document can still be improved. In fact, the use of carbonaceous fillers leads to the production of porous coatings which do not make it possible to ensure an optimal role of protection of the coating against oxidation-corrosion phenomena. Moreover, the use of metal salts, such as I₂, reacts with disilicate, thus degrading its oxidation-corrosion protection properties.

Using a rare earth disilicate solution in combination with boron (for densifying the environmental barrier) and an iron oxide (acting as a sintering agent) is also known. But the same problem as that described above is observed.

The object of the present invention is precisely to provide a solution to this problem.

### PRESENTATION OF THE INVENTION

To this end, the invention relates to a method for producing an environmental barrier coating by electrophoresis on a ceramic matrix composite material part, the method comprising the following steps:
E10: application by electrophoresis on the surface of the part of a liquid suspension of a composition comprising at least one powder of a rare earth silicate as well as conductive fillers;
E20: drying of the suspension applied; and
E30: sintering heat treatment of rare earth silicate powder,
characterized in that use is made, as conductive fillers, of at least one nitrate chosen from the group consisting of aluminum, yttrium and ytterbium nitrates in a quantity comprised between 0.2 and 1 millimole per liter of liquid suspension.

The present applicant was surprised to find that by selecting salts from the above-mentioned nitrates, particularly homogeneous coatings of uniform thickness can be obtained at a salt concentration as low as the one also indicated above.

Thus, in the case of conductive suspensions, the potential drop in the suspension is greater, and therefore the driving force for the formation of the coating becomes weaker, which reduces the zones of concentration of electric field lines. This adjustment of the electrical conductivity makes it possible to obtain more homogeneous coatings and to avoid “edge effects” and/or “geometric effects”.

Moreover, such a concentration makes it possible to increase the electrical conductivity of the suspension very markedly, without disrupting its stability.

In addition, these additions of salts will, after heat treatment, form alumina, yttria (yttrium oxide) or ytterbium oxide, thus helping to densify the coating.

According to other advantageous and non-limiting characteristics of this method, taken alone or in any technically compatible combination of at least two of them:
the composition of the suspension comprises sintering agents with a proportion by mass in said composition of approximately 0 to 5% of sintering agents;
the mass content of the rare earth silicate powder is comprised between approximately 0.5 to 30%, or between approximately 1 to 10%;
the mean particle size of the rare earth silicate powder is less than or equal to approximately 5 μm, or less than or equal to approximately 1 μm;
the composition of the suspension comprises a solvent whose mass content in said composition is comprised between approximately 70% and 99%, or between approximately 85% and 95%;
the sintering agents are either oxide fillers of the Fe₂O₃, Al₂O₃, MgO, CaO or RE₂O₃ type (RE=rare earth), or precursor sols of these oxides, or precursor sols of rare earth silicate;
to achieve a given thickness of environmental barrier, steps E10 to E30 are repeated several times until the desired thickness is obtained;
said part is a turbomachine part.

### DESCRIPTION OF THE FIGURES

Other characteristics and advantages of the invention will become apparent from the description which will now be given, with reference to the attached drawings, which represent, by way of non-limiting indication, a possible embodiment thereof.

In these drawings:

FIG. 1 schematically illustrates the steps implemented in order to form an environmental barrier according to the method of the invention;

FIG. 2 shows a part comprising a ceramic material and an environmental barrier formed according to the invention;

FIG. 3 is a scanning electron microscope micrograph of the edge of a specimen coated by electrophoresis, in accordance with the prior art;

FIG. 4 is a scanning electron microscope micrograph of the edge of a specimen coated by electrophoresis, in accordance with the method according to the present invention.

### DETAILED DESCRIPTION OF THE INVENTION

The following detailed description considers the formation of an environmental barrier on the surface of a part made of silicon-containing CMC material. However, it is recalled that the invention is applicable to a part made of a ceramic matrix composite material containing silicon and, more generally, to a part for which at least one adjacent part is coated with a silicon layer.

The part made of CMC material containing silicon comprises a fibrous reinforcement which can be made of carbon fibers (C) or ceramic fibers, for example SiC fibers.

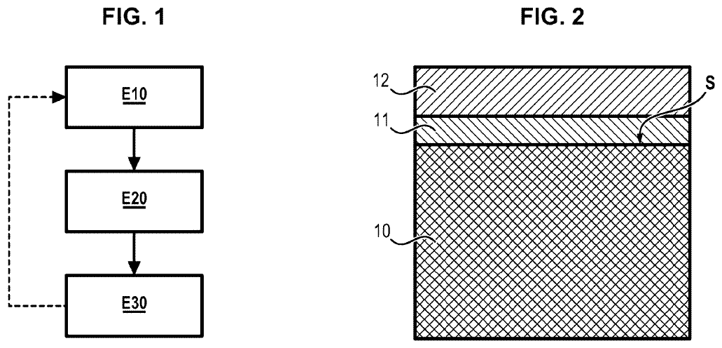

The formation of an environmental barrier on a CMC part will now be described with reference to FIG. 1 which illustrates the different steps of an example of a coating method, as well as in connection with FIG. 2 which illustrates a part made of CMC material 10 with a coating produced by this method.

The part can be a static or rotating part of a turbomachine. The turbomachine part can, for example, be a part present in a hot part of the turbomachine, such as a turbine, and constitute, for example, a turbine blade, a part of a turbine ring, etc.

In a first step E10 of the method, a suspension is applied to the surface S of the CMC part 10.

The suspension used during an electrophoresis method is applied to a bonding layer 11 comprising silicon and present beforehand on the surface S of the part 10. In this example, the suspension is applied directly to the bonding layer 11, that is to say in contact with this layer). This bonding layer can be a silicon or metal silicide layer.

However, it would not exceed the scope of the invention for the suspension to be applied directly to the surface of the CMC part (in direct contact with the part in the absence of the bonding layer 11).

The bonding sublayer 11, known in itself, makes it possible to ensure good adhesion of the environmental barrier coating 12 to the part 10. More generally, such a bonding sublayer 11 ensures a good mechanical compatibility between the first environmental barrier coating 12 and the surface S, especially compensating for the differential thermal expansion that can exist between the materials of the coating 12 and the CMC part 10.

In the case where the part 10 comprises a ceramic matrix composite material, the bonding sublayer 11 can comprise silicon or a metal silicide. In general, the material of the bonding sublayer 11 is adapted according to the materials forming the part 10 and the coating 12.

A prior step, known in itself, consists firstly of depositing the bonding sublayer 11 on the surface S of the part 10, for example by thermal spraying or by vapor deposition (CVD or PVD).

The environmental barrier coating 12 is then deposited (step E10) on the bonding sublayer 11. The coating composition is applied by an electrophoretic deposition method.

The suspension comprises a liquid medium in which at least one powder of a rare earth silicate RESIO is present, chosen from: rare earth disilicates or monosilicates, where the rare earth is yttrium, ytterbium, lutetium or erbium, for example.

In one embodiment, the rare earth silicate powder is selected from the following silicate forms: Y₂Si₂O₇, Yb₂Si₂O₇, Y₂SiO₅, Yb₂SiO₅ and Yb₂Si₂O₇.

The mass content of the rare earth silicate powder can be comprised between approximately 0.5% and 30%, and preferably between approximately 1% and 10%. The mean particle size of the rare earth silicate powder can be less than or equal to approximately 5 μm, and preferentially less than or equal to approximately 1 μm.

The liquid medium can be, for example, water or an alcohol, such as ethanol, isopropanol, 1-propanol or a mixture of at least two of these alcohols. The mass content of the solvent in the liquid medium can be comprised between approximately 70% and 99%, and preferably between approximately 85% and 95%.

The liquid medium also comprises, in accordance with the invention, at least one salt soluble in this medium, chosen from aluminum, yttrium and ytterbium nitrates (Al(NO₃)₃, Yb(NO₃)₃ and Y(NO₃)₃), in a quantity comprised between 0.2 and 1 millimole per liter of liquid.

The liquid medium also comprises, by mass content, between approximately 0 and 5% of the sintering agents. The sintering agents are, for example, either oxide fillers of the Fe₂O₃, Al₂O₃, MgO, CaO or RE₂O₃ (RE=rare earth) type, or precursor sols of the oxides mentioned above, or precursor sols of the rare earth silicate, the addition of which in very small quantities significantly improves the density of the coating thus produced.

In electrophoresis, the part 10 constitutes an electrode of the electrophoresis system facing which a counter electrode is present. The counter electrode is, for example, made of platinum.

A generator imposes a potential difference between the part 10 and the counter-electrode. The generator is direct current or pulsed. The part 10 is polarized at a charge opposite to that of the particles suspended in the liquid medium. Due to the application of an electric field between the part 10 and the counter electrode, said particles move and are deposited on the part 10 to form a ceramic coating.

Preferably, the voltage applied by the generator is comprised between approximately 50 V and 200 V. The duration of the deposition by electrophoresis is comprised between approximately 1 and 30 min.

The addition of nitrate according to the quantity indicated above makes it possible to increase the electrical conductivity (between 1 and 5 μS/cm and more particularly between 2 and 2.5 μS/cm) of the suspension without disrupting its stability.

After the step of preparing the coating by electrophoresis, the CMC part 10 coated with the suspension composition is subjected to a step of drying the deposit in a step E20. During this drying step, all or part of the liquid medium is evaporated.

Drying can be carried out, for example, between approximately 50 and 200 C, over a period of, for example, approximately 5 min to 2 h.

Then, in a step E30, the CMC part 10 undergoes a sintering heat treatment with the aim of continuing the densification of the coating.

During the sintering heat treatment, the organic compounds are pyrolyzed and the sintering agents will react with the rare earth silicate to heal the coating during the sintering heat treatment and allow better densification.

Moreover, during this sintering heat treatment, the above-mentioned nitrate(s) will oxidize to form alumina, yttria or ytterbium oxide and thus participate in the densification of the coating.

The sintering heat treatment is preferably carried out between approximately 1200 and 1400° C., over a period of approximately 1 to 50 h.

At the end of steps E10 to E30, the environmental barrier 12 can be obtained by carrying out each of steps E10 to E30 only once. As a variant, steps E10 to E30 can be repeated in order to obtain the environmental barrier 12. Thus, in order to achieve a desired thickness, it is possible, for example, to produce the environmental barrier 12 by carrying out the succession of steps E10 to E30 at least twice, or even at least four times.

The thickness of the environmental barrier obtained by electrophoresis can, in particular, be comprised between approximately 25 and 100 μm.

The method described thus makes it possible to obtain homogeneous coatings of uniform thickness even on parts of complex shapes. The conductive silicon bonding sublayer facilitates the implementation of the environmental barrier by electrophoresis. Indeed, by the use of nitrates according to the invention, combined with the addition of sintering agent, it is possible both to obtain a very good regularity of the deposit due to the improvement of the conductivity of the rare earth silicate suspension and to improve the densification of the environmental barrier thus developed by means of the use of sintering agent.

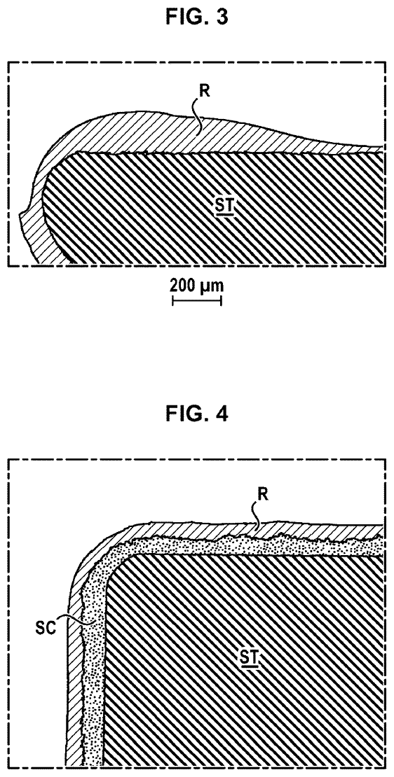

FIG. 3 shows a scanning electron microscope micrograph of the edge of a specimen coated by electrophoresis, in accordance with the prior art. The edge effect of the coating R on the substrate ST is very easily observed, i.e., this absence of regularity of the coating R in the angular part of the substrate.

In contrast, according to FIG. 4, which is a scanning electron microscope micrography of the edge of a specimen coated by electrophoresis in accordance with the method according to the present invention, the extreme regularity of the coating R is observed, while the coating is here visually distinguished from the underlying bonding sublayer SC.

An example of a coating of a part is described in detail below.

In this case, it is an object of complex shape consisting of a turbomachine blade previously obtained by 3D printing.

According to the invention, an environmental barrier coating is formed using a suspension composed of:
Solvent: Propan-2-ol containing:
5% by mass of YbDS (ytterbium disilicate)/solvent;
1% by mass of Fe₂O₃/YbDS;
1% by mass of boron/YbDS;
0.25% by mass of (NO₃)₃Al, 9H₂O/YbDS.

Deposition parameters: 3 min at 100 V.

This results in a homogeneous coating over the entire surface of the blade, even on the platforms it comprises. This also applies after a heat treatment at 1350° C. for 5 h under a stream of air.

1-8. (canceled)

9. A method for producing an environmental barrier coating by electrophoresis on a ceramic matrix composite material part, the method comprising the following steps:
a): application by electrophoresis on the surface of the ceramic matrix composite material part of a liquid suspension of a composition comprising at least one powder of a rare earth silicate as well as conductive fillers;
b): drying of the liquid suspension applied in step a); and
c): sintering heat treatment of the powder of rare earth silicate, wherein, in step a), at least one nitrate chosen from the group consisting of nitrates of aluminum, of yttrium and of ytterbium in a quantity comprised between 0.2 and 1 millimole per liter of liquid suspension is used as conductive fillers.

10. The method according to claim 9, wherein the composition of the liquid suspension comprises sintering agents with a proportion by mass in said composition of approximately 0 to 5% of sintering agents.

11. The method according to claim 9, wherein the mass content of the rare earth silicate powder is comprised between approximately 0.5 to 30%, or between approximately 1 to 10%.

12. The method according to claim 9, wherein the mean particle size of the rare earth silicate powder is less than or equal to approximately 5 μm, or less than or equal to approximately 1 μm.

13. The method according to claim 9, wherein the composition of the liquid suspension comprises a solvent whose mass content in said composition is comprised between approximately 70% and 99%, or between approximately 85% and 95%.

14. The method according to claim 10, wherein the sintering agents are either oxide fillers of the Fe₂O₃, Al₂O₃, MgO, CaO RE₂O₃ type (RE=rare earth), or precursor sols of these oxides, or precursor sols of rare earth silicate.

15. The method according to claim 11, wherein the sintering agents are either oxide fillers of the Fe₂O₃, Al₂O₃, MgO, CaO RE₂O₃ type (RE=rare earth), or precursor sols of these oxides, or precursor sols of rare earth silicate.

16. The method according to claim 12, wherein the sintering agents are either oxide fillers of the Fe₂O₃, Al₂O₃, MgO, CaO RE₂O₃ type (RE=rare earth), or precursor sols of these oxides, or precursor sols of rare earth silicate.

17. The method according to claim 13, wherein the sintering agents are either oxide fillers of the Fe₂O₃, Al₂O₃, MgO, CaO RE₂O₃ type (RE=rare earth), or precursor sols of these oxides, or precursor sols of rare earth silicate.

18. The method according to claim 9, wherein steps a) to c) are repeated several times until a desired thickness of environmental barrier is obtained.

19. The method according to claim 9, wherein the ceramic matrix composite material part is a turbomachine part.
